(19) United States
(12) Patent Application Publication
(10) Pub. No.: US 2026/0030138 A1
(43) Pub. Date: Jan. 29, 2026

(54) METHOD, APPARATUS, DEVICE, AND STORAGE MEDIUM FOR APPLICATION PERFORMANCE DETECTION

(71) Applicant: Beijing Zitiao Network Technology Co., Ltd., Beijing (CN)

(72) Inventors: Hailin Wen, Beijing (CN); Yifan Yang, Beijing (CN)

(21) Appl. No.: 19/280,449

(22) Filed: Jul. 25, 2025

(30) Foreign Application Priority Data
Jul. 25, 2024 (WO) PCT/CN2024/107667

(51) Int. Cl. G06F 11/3604; H04W 76/10

(52) U.S. Cl. CPC G06F 11/3612; H04W 76/10

(57) ABSTRACT

According to an embodiment of the disclosure, a method, apparatus, device and storage medium are provided. In the method, running data resulting from a target application performing a target operation is obtained, the target operation comprising a plurality of acts, the running data at least indicating a last act of the plurality of acts performed by the target application during performing the target operation at at least one client. State feedback information for the plurality of acts is determined based on the running data, the state feedback information indicating a performed state of each act of the plurality of acts. Performance information of the target application is determined based on the state feedback information.

### CROSS-REFERENCE

This application claims priority to PCT Patent Application No. PCT/CN2024/107667, filed on Jul. 25, 2024 and entitled ‘METHOD, APPARATUS, DEVICE, AND STORAGE MEDIUM FOR APPLICATION PERFORMANCE DETECTION’, which is incorporated herein by reference in its entirety.

### FIELD

Example embodiments of the present disclosure generally relate to the field of computers, and in particular, to a method, apparatus, device and computer readable storage medium for application performance detection.

### BACKGROUND

More and more applications are designed to provide various services to users. The user may perform various operations on the application. For example, a user may play various types of media contents, such as images, videos, audios, etc., in a content sharing application. However, the application may be abnormal in the working process, affecting normal use of the user.

### SUMMARY

In a first aspect of the present disclosure, a method for application performance detection is provided. The method comprises: obtaining running data resulting from a target application performing a target operation, the target operation comprising a plurality of acts, the running data at least indicating a last act of the plurality of acts performed by the target application during performing the target operation at at least one client; determining, based on the running data, state feedback information for the plurality of acts, the state feedback information indicating a performed state of each act of the plurality of acts; and determining, based on the state feedback information, performance information of the target application.

In a second aspect of the present disclosure, an apparatus for applying performance detection is provided. The device comprises: an obtaining module configured to obtain running data resulting from a target application performing a target operation, the target operation comprising a plurality of acts, the running data at least indicating a last act of the plurality of acts performed by the target application during performing the target operation at at least one client; a first determining module configured to determine, based on the running data, state feedback information for the plurality of acts, the state feedback information indicating a performed state of each act of the plurality of acts; and a second determining module configured to determine, based on the state feedback information, performance information of the target application.

In a third aspect of the present disclosure, an electronic device is provided. The apparatus includes at least one processing unit; and at least one memory coupled to the at least one processing unit and storing instructions for execution by the at least one processing unit, the instructions, when executed by the at least one processing unit, causing the electronic device to perform the method the first aspect.

In a fourth aspect of the present disclosure, a computer-readable storage medium having a computer program stored thereon is provided. The computer program is executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure may be implemented;

FIG. 2 illustrates a schematic diagram of an example of an application performance detection system according to some embodiments of the present disclosure;

FIG. 3 illustrates a schematic diagram of an example of an act of a target operation according to some embodiments of the present disclosure;

FIG. 4 illustrates a schematic diagram of running state data according to some embodiments of the present disclosure;

FIG. 5 illustrates a schematic diagram of an example of state feedback information according to some embodiments of the present disclosure;

FIG. 6 illustrates a schematic diagram of a further example of state feedback information according to some embodiments of the present disclosure;

FIG. 7 shows a schematic diagram of an example of application performance analysis according to some embodiments of the present disclosure;

FIG. 8 shows a flowchart of a process of application performance detection according to some embodiments of the present disclosure;

FIG. 9 illustrates a block diagram of an apparatus for application performance detection according to some embodiments of the present disclosure; and

FIG. 10 illustrates a block diagram of a device capable of implementing various embodiments of the present disclosure.

### DETAILED DESCRIPTION

It may be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to obtain and use the personal information of the user. Therefore, the user may autonomously select whether to provide personal information to software or hardware performing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “disagree” to provide personal information to the electronic device.

It may be understood that the foregoing notification and process of obtaining a user authorization is merely illustrative and does not constitute a limitation on implementations of the present disclosure, and other manners of meeting related laws and regulations may also be applied to implementations of the present disclosure.

It may be understood that the data involved in the technical solution (including but not limited to the data itself, the obtaining or use of the data) should follow the requirements of the corresponding laws, regulations and related regulations.

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein, but rather, these embodiments are provided for a more thorough and complete understanding of the present disclosure. It should be understood that the drawings and embodiments of the present disclosure are for example purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

Herein, unless explicitly stated, “in response to A” performs one step and does not imply that this step is performed immediately after “A” but may include one or more intermediate steps.

In the description of the embodiments of the present disclosure, the terms “including”, and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

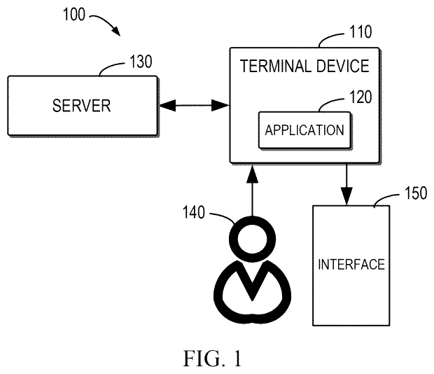

FIG. 1 illustrates a schematic diagram of an example environment 100 in which embodiments of the present disclosure may be implemented. In the example environment 100, an application 120 is installed in a terminal device 110. A user 140 may interact with the application 120 via the terminal device 110 and/or an attachment device of the terminal device 110. For example, the application 120 may be a content generation application, a content sharing application, or a social application, which may provide services related to a media content to the user 140, including browsing, commenting, forwarding, creating (e.g., shooting and/or editing), publishing, and the like of the content. “Media content” may include one or more types of contents, such as video, images, animated images, image sets, audio, text, and the like. The application 120 may support the user 140 in creating multimedia contents. Such multimedia content may include image data and audio data.

In environment 100 of FIG. 1, the terminal device 110 may present a user interface 150 of the application 120. The user interface 150 may include various interfaces that the application 120 may provide, such as a content presentation interface, a content authoring interface, a content publication interface, a message interface, a personal homepage, and so forth. The application 120 may provide a content browsing function to browse various types of content published in the application 120. The application 120 may also provide content authoring functionality, including taking, uploading, editing, and/or publishing media content.

In some embodiments, the terminal device 110 communicates with a server 130 to implement provisioning of services to the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 may also support any type of interface for a user (such as a “wearable” circuit, etc.). The server 130 may be various types of computing systems/servers capable of providing computing power, including but not limited to, mainframes, edge computing nodes, computing devices in a cloud environment, and the like.

It should be understood that the structures and functions of the various elements in the environment 100 are described for example purposes only and do not imply any limitation to the scope of the present disclosure. For example, embodiments of the present disclosure may be applied to any suitable one or more applications, not limited to office suites.

As briefly mentioned above, applications are designed to provide various services to users. During operating an application by a user, an application cannot normally perform an operation instruction of the user due to a fault of the application and/or a fault of an environment in which the application is running. For example, a user plays various types of media contents in a content sharing application. If the application is faulty, it may appear that the media content cannot be played and cannot normally serve the user. In order to better serve the user, the application developer needs to have an accurate picture of the performance of the application, so as to optimize the application in time.

At present, the developer mainly determines the application performance based on the ratio of the number of users whose instructions were successfully performed by the application over a period of time to a total number of users who started the application. For example, in a content sharing application, the performance of an application is usually measured by a ratio of the number of users who successfully played the media content to the number of users who started the application in one day. The application performance calculation formula is as follows:

$${α}_{0 vv} = 1 - {user}_{vv} / {user}_{all} \qquad ( 1 )$$

wherein α_{0νν} is the ratio of the number of users who fails to play a media content successfully during a detection period (usually one day) to the number of users who started the application, which is used to indicate the application performance. user_{νν} is the number of users who fails to play a media content successfully during a detection period. userₐₗₗ is the number of users who started an application during a detection period.

However, in this manner, the developer may only determine the application performance, not the cause of an inability of the application to perform user operation instructions and is unable to provide data to support the developer in analyzing application performance and maintaining the application.

Therefore, embodiments of the present disclosure provide a solution for application performance detection. According to an embodiment of the present disclosure, running data resulting from a target application performing a target operation is obtained, the target operation comprising a plurality of acts, the running data at least indicating a last act of the plurality of acts performed by the target application during performing the target operation at at least one client. State feedback information for the plurality of acts is determined based on the running data, the state feedback information indicating a performed state of each act of the plurality of acts. Performance information of the target application is determined based on the state feedback information.

In an embodiment of the present disclosure, the state feedback information of the act performed during performing the target operation by the target application may be determined by obtaining the resulted running data. The performance of the target application is determined based on the state feedback information of each act. Therefore, the process of performing the target operation on the application may be monitored based on the state feedback information, so that the fault node of the application is accurately positioned, and technical support is provided for the developer to optimize the application performance.

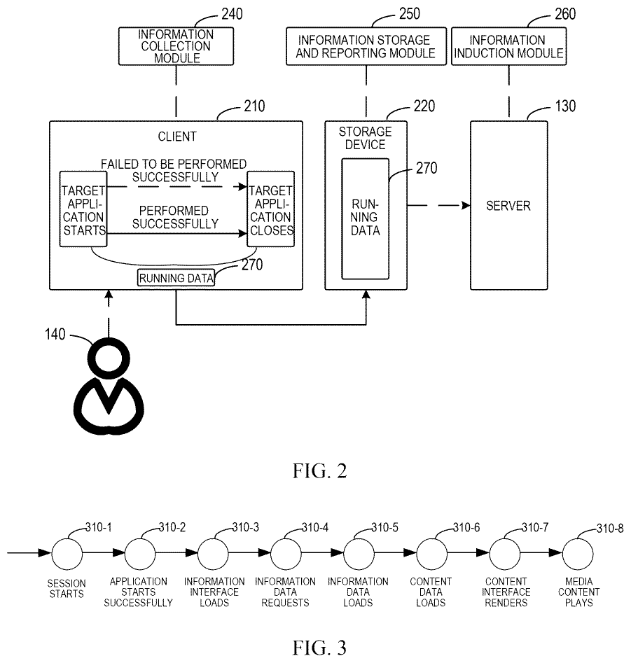

FIG. 2 illustrates a schematic diagram of an example of an application performance detection system 200 according to some embodiments of the present disclosure. As shown in FIG. 2, the application performance detection system includes an information collection module 240, an information storage and reporting module 250, and an information induction module 260.

In some embodiments, the information collection module 240 may be implemented or included in the terminal device 110. A client 210 of a target application is set in the terminal device 110. The user 140 sends an operation instruction to the client 210 of the target application through a human-computer interaction apparatus (for example, a touch screen or a keyboard, a mouse, etc.) to control the target application. The operation instruction corresponds to a type of the target application. For example, if the target application is a content sharing application, the operation instruction may be to control the target application to play a media content or upload a media content. The media content may include, but is not limited to, images, videos, audio, and the like. If the target application is a game application, the operation instruction may be to control a virtual object in the target application.

In some embodiments, if it is detected that the user 140 sends an operation instruction to the target application, the client 210 performs the received operation instruction. The information collection module 240 is configured to collect the running data 270 resulted from performing the operation instruction by the client 210. The information collection module 240 may obtain the running data 270 of the client 210 and provide all the obtained the running data 270 to the subsequent module. Alternatively or in addition, the information collection module 240 may analyze the collected the running data 270 and provide the state feedback information obtained after the analysis or the performed state of each act to the subsequent module. The running data includes, but is not limited to, user interaction data for indicating user interaction behavior, terminal device performance data (e.g., response time, load time, memory usage, processor usage, etc., of the target application), network data (e.g., data requests, request response times, etc.) for indicating network requests and responses between the target application and the server, and log files (e.g., start data, shutdown data, update data, etc.) indicating system events during the running of the target application.

The running data 270 includes a performed state of each act during a target application performing a target operation. That is, the running data 270 indicates whether any act was successfully performed during the performance of the target operation. In some embodiments, the information collection module 240 determines, based on the collected running data, a number of times each act is successfully performed and a number of times of performing failure during the target application performing the target operation in the one or more clients. Alternatively or in addition, the state feedback information of each act may be determined by the subsequent module based on the running data 270 provided by the information collection module 240. The system 200 will be described below primarily with the information collection module 240 only responsible for collecting and providing the running data 270 to subsequent modules, but this is merely as an example.

In some embodiments, whether the act is successfully performed may be performed by an “act identification-performed state” data pair. For example, a first act-successfully performed, and a second act-performed failed. The running data 270 provided by the information collection module 240 to the subsequent modules may include performed states of all acts. For example, the running data 270 may include a plurality of “act identification-performed state” data pairs. The performed state of the running data 270 may be determined by each data pair. Alternatively or in addition, the running data 270 may include only partial acts (acts successfully performed or acts failed to be performed successfully). For example, the running data 270 only includes identification information of the successfully performed act, and an act not appearing in the running data 270 is an act failed to be performed successfully. In some embodiments, the running data 270 may include only a last act performed by the target application in performing the target operation. If the last act is failed to be performed successfully, it indicates that the target application fails to perform the target operation successfully.

In some embodiments, the target operation includes one or more acts. During a target application performing a target operation, different acts need to be performed in a sequence of acts. A core path for performing the target operation may be determined based on an order in which the target application performs each action. The core path includes a node corresponding to each act. For example, if the target operation is to play a media content, an act to be performed by the target application at least includes data request, data loading, interface rendering, and the like. If the target application successfully performs all acts, it indicates that the target application successfully performs the target operation. If the target application fails to perform the target operation successfully, it indicates that an error occurred in the target application during performing the corresponding target operation, resulting in part of the acts failed to be performed successfully.

FIG. 3 illustrates a schematic diagram of an example of an act 300 included in a target operation according to some embodiments of the present disclosure. As shown in FIG. 3, the target application is a content sharing application, and the target operation is to play a media content operation. The path in which the target application performs the target operation includes a plurality of nodes, and each node respectively corresponds to each act during performing an operation of playing a media content. For example, an act 310-1 of session starting, an act 310-2 of application starting successfully, an act 310-3 of information interface loading, an act 310-4 of information data requesting, an act 310-5 of information data loading, an act 310-6 of content data loading, an act 310-7 of content interface rendering, and an act 310-8 of media content playing. These acts may be individually or collectively referred to as acts 310. The performed state of each act 310 during each performance of the target operation and the state feedback information of each act 310 are determined based on the running data 270.

During a starting process of the target application, a time at which the user 140 sends an operation instruction to the client 210 cannot be determined. The user 140 may send an operation instruction to the application at a previous moment when the application is closed, in which case the application may stop running suddenly, which may cause data loss. In some embodiments, in order to more accurately detect the performance of the application, the performance of the target application may be determined based on the running data 270 resulting from the target application in each session. Each session indicates the user 140 to start the target application and the user 140 to close the target application for this application running period. The running data 270 collected by the information collection module 240 corresponds to a plurality of sessions, and the target application performs the data resulted from the target operation.

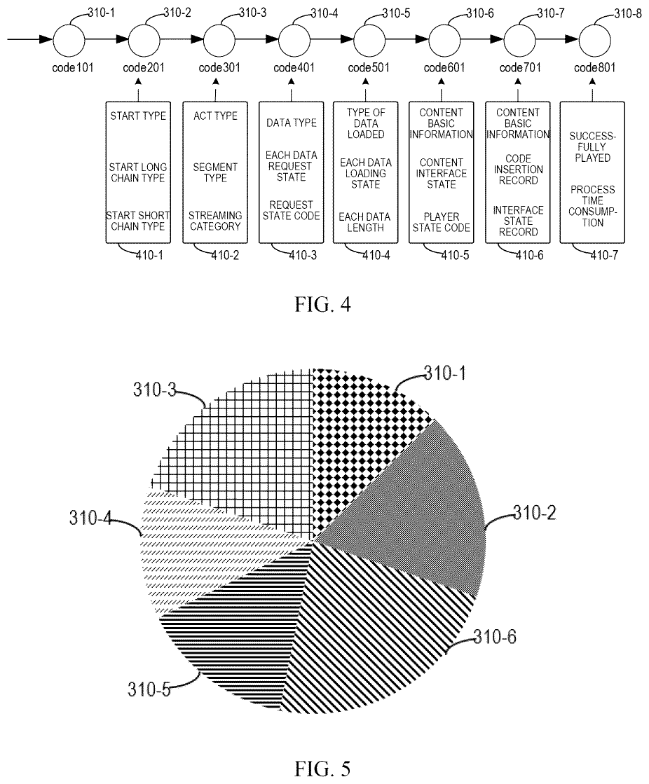

In some embodiments, to facilitate the developer to analyze the reason for failure of performing the act 310, the information collection module 240 may also provide the developer with the running state information 410 of the target application during the performance of the target operation. FIG. 4 shows a schematic diagram of running state data 400 according to some embodiments of the present disclosure. As shown in FIG. 4, each act 310 has corresponding running state information 410. For example, when the target application is a content sharing application, and the target operation is a media content playing operation, an operation state data 410-1 corresponding to the act 310-2 of application starting successfully includes a start type, a start long chain type, and a start short chain type. The state running data 410-5 corresponding to the act 310-6 of content data loading includes content basic information, a content interface state, and a player state code. The state data corresponding to each act 310 may be individually or collectively referred to as running state data 410.

In some embodiments, the information collection module 240 may set a code for each act 310 in the operation performing path. The running data may include a code of a performed act or a code of a last performed act. The information collection module 240 provides the running data 270 containing only successfully performed acts 310 to a subsequent module to facilitate subsequent modules determining the state feedback information for each act 310. For example, it is determined that the code corresponding to the act 310-1 of session starting is code 101, the code corresponding to the act 310-2 of application starting successfully is code 201, the code corresponding to the act 310-3 of information interface loading is code 301, the code corresponding to the act 310-4 of information data requesting is 401, and the code corresponding to the act 310-5 of information data loading is 501, . . . , and the code corresponding to the act 310-8 of media content playing is 901. If the target operation fails in performing the act 310-4 of information data requesting, the information collection module provides only the codes (including code 101, code 201, code 301) of the preamble act 310. The developer may determine that the target operation failed to be performed successfully due to the unsuccessful performance of the act 310-4 of information data requesting.

Continuing with FIG. 2. After obtaining the running data 270, the information collecting module 240 may directly provide the running data 270 to the server 130, so as to facilitate the server 130 to analyze the performance information of the target application. The information collection module 240 is usually connected to the server 130 through a network and a loaded network abnormality may lead to a data loss situation. Therefore, the information collection module 240 may provide the collected the running data 270 to the information storage and reporting module 250.

The information storage and reporting module 250 is configured to store the running data 270 and provide the running data 270 to the server 130 when establishing a connection with the server 130. In some embodiments, the information storage and reporting module 250 may be a separately set storage device 220 or may be a storage device 220 set at the client 210. The information storage and reporting module 250 integrates the provided the running data 270 into a composite key-value pair data (e.g., act 310 identification-performed state) and holds the key-value pair data in the storage device 220.

In some embodiments, the information storage and reporting module 250 may store data in a data queue. If there are a plurality of groups of the running data 270 corresponding to different sessions, the data entries corresponding to the plurality of groups of the running data 270 are stored in the storage device 220 in a queue. If the information storage and reporting module 250 establishes a connection with the server 130, the corresponding data entry is uploaded to the server 130.

In some embodiments, the information storage and reporting module 250 may actively upload the running data 270 corresponding to each client 210 to the server 130. After obtaining the data request of the server 130, the running data 270 of the client 210 corresponding to the data request may also be uploaded to the server 130. Alternatively or in addition, the information storage and reporting module 250 may be implemented or included in the server 130.

As shown in FIG. 2, the information induction module 260 may be implemented or included in the server 130. The information induction module 260 is responsible for processing the running data 270 received by the server. After obtaining the provided running data 270, the information induction module 260 performs data verification to remove part of the invalid data. For example, the information induction module 260 may perform a check on the integrity of the data and delete incomplete data.

The information induction module 260 is configured to determine the performance of the target application based on the provided running data 270. In some embodiments, the information induction module 260 may determine, based on the obtained running data, state feedback information for a plurality of acts included in the target operation. The state feedback information indicates a performed state of each acts. For example, if an act is failed to be performed successfully, a failure record corresponding to the act may be added to the state feedback information, so as to analyze a reason why the target operation fails to be performed. The failure record may include identification information of the failure act and the like. Further, based on the state feedback information, the information induction module 260 may determine performance information of the target application. That is, performance analysis may be performed on the target application.

In some embodiments, the performance analysis may include determining a performing failure rate, e.g., 0vv rate, of the target performance. Specifically, the information induction module 260 may determine, based on the provided the running data 270, a first number of sessions corresponding to the running data 270; determine, based on the state feedback information, that the running data 270 corresponds to a second number of sessions during which the target operation failed to be performed successfully; and determine a performing failure rate of the target operation based on a ratio of the first number to the second number The calculation formula for the performing failure rate β_{0νν} is as follows:

$${β}_{0 vv} = {session}_{0 vv} / {session}_{all} \qquad ( 2 )$$

wherein session_{0νν} indicates the number of sessions in which a target operation failed to be performed successfully during a session, and sessionₐₗₗ indicates the total number of sessions.

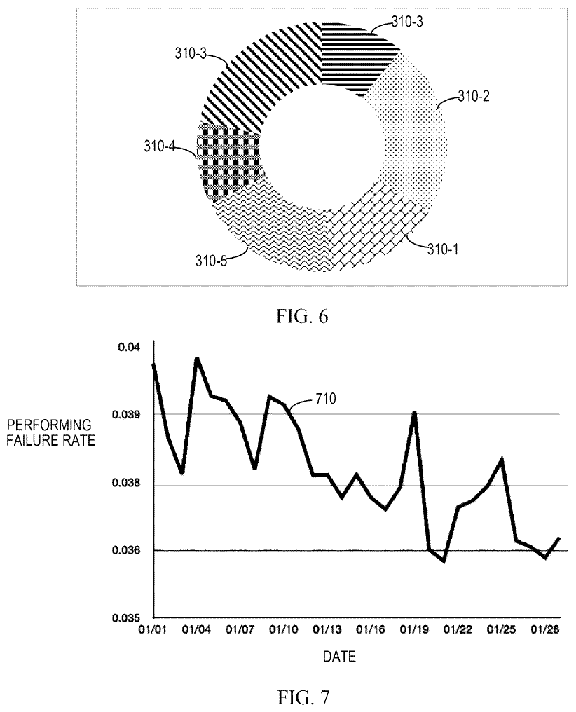

In some embodiments, analyzing the performance of the target application may include generating a related data report of the act 310 corresponding to the target operation. FIG. 5 illustrates a schematic diagram of an example of state feedback information 500 according to some embodiments of the present disclosure. FIG. 6 illustrates a schematic diagram of a further example of state feedback information 600 according to some embodiments of the present disclosure. FIG. 5 shows a ratio of a frequency with which different actions 310 are performed over a plurality of sessions. FIG. 6 illustrates a ratio of failed performances of different actions 310 resulting in a failed performance of a target operation. Based on the content shown in FIG. 5 and FIG. 6, performance information of the target application, that is, a performed state of each act 310, may be determined to determine a reason for the target application fails to perform the target operation. In some embodiments, the information induction module 260 may be further configured to determine, based on the state feedback information, the running state information 410 when the second act 310 is failed to be performed successfully. Based on the running state information 410, a failure cause related to the second act 310 is analyzed for the target application. Based on the performance information, the state feedback information, and the running state information 410 obtained above, the information induction module 260 may construct a funnel for the target operation to analyze the cause of the failure for each specific operation. In addition, the information induction module 260 may also perform error attribution and optimization insights on the reasons for failure in performing the target operation, in order to provide data support for developers to optimize the performance of the application.

FIG. 7 shows a structural diagram of an example of an application performance analysis 700 according to some embodiments of the present disclosure. As shown in FIG. 7, the information induction module 260 may monitor an overall performance change of the application for a long time. When the target application has a fault, the problem existing in the target application may be efficiently located, and the use experience of the user 140 is improved. As shown by curve 710 in FIG. 7, the performing failure rate of the target application to perform the target operation gradually decreases over time.

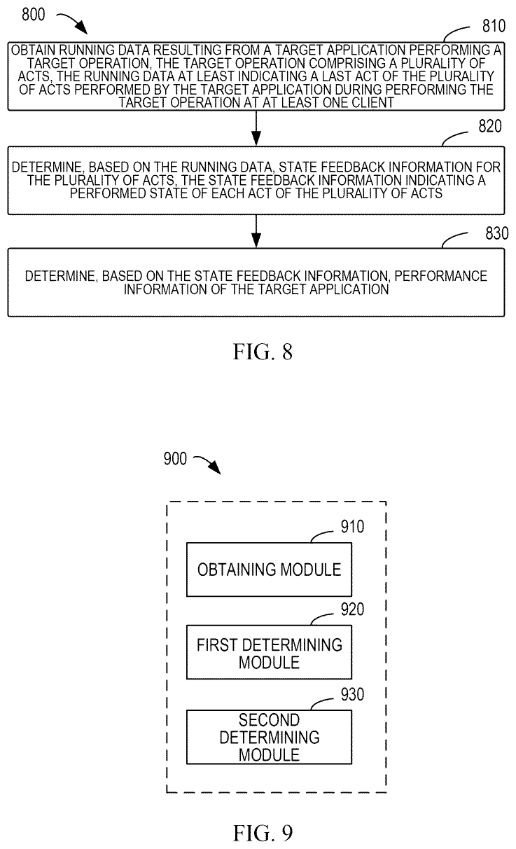

FIG. 8 shows a flowchart of a process 800 for application performance detection according to some embodiments of the present disclosure. The process 800 may be implemented or included at service 130.

At block 810, the server obtains running data resulting from a target application performing a target operation, the target operation comprising a plurality of acts, the running data at least indicating a last act of the plurality of acts performed by the target application during performing the target operation at at least one client.

In some embodiments, the running data corresponds to a plurality of sessions for performing the target operation, and the running data comprises data resulting from performing the target operation during each of the plurality of sessions.

In some embodiments, obtaining running data resulting from a target application performing a target operation comprises: in response to that the server establishes a connection with a given client of the at least one client, receiving from the given client at least a portion of the running data, the at least a portion of the running data indicating a last act performed in the plurality of acts during performing the target operation at the given client.

In some embodiments, the at least a portion of the running data comprises a plurality of data entries respectively corresponding to a plurality of performing times of the target operation at the given client, and the plurality of data entries are stored at the given client in a queue before the connection is established.

In some embodiments, the target operation comprises playing a media content in the target application.

At block 820, the server determines, based on the running data, state feedback information for the plurality of acts, the state feedback information indicating a performed state of each act of the plurality of acts.

In some embodiments, determining the state feedback comprises: in response to the running data indicating that the last act performed is a first act of the plurality of acts, adding a failure record corresponding to the first act in the state feedback information.

At block 830, the server determines, based on the state feedback information, performance information of the target application.

In some embodiments, determining performance information of the target application comprises: determining a first number of sessions corresponding to the running data; determining, based on the state feedback information, that the running data corresponds to a second number of sessions during which the target operation failed to be performed successfully; and determining a performing failure rate of the target operation based on a ratio of the first number to the second number.

In some embodiments, the process 800 further includes: determining, for a second act of the plurality of acts, running state data where the second act fails to be performed successfully based on the state feedback information; and analyzing, for the target application, a failure cause related to the second act based on the running state data.

FIG. 9 is a schematic structural block diagram of an apparatus 900 for application performance detection according to some embodiments of the present disclosure. The apparatus 900 may be implemented or included in the server 130. The various modules/components in the apparatus 900 may be implemented by hardware, software, firmware, or any combination thereof.

As shown in the figure, the apparatus 900 includes an obtaining module 910, configured to obtain running data resulting from a target application performing a target operation, the target operation comprising a plurality of acts, the running data at least indicating a last act of the plurality of acts performed by the target application during performing the target operation at at least one client. The apparatus 900 further includes a first determining module 920 configured to determine, based on the running data, state feedback information for the plurality of acts, the state feedback information indicating a performed state of each act of the plurality of acts. The apparatus 900 further includes a second determining module 930 configured to determine, based on the state feedback information, performance information of the target application.

In some embodiments, the first determining module 920 is further configured to, in response to the running data indicating that the last act performed is a first act of the plurality of acts, add a failure record corresponding to the first act in the state feedback information.

In some embodiments, the second determining module 930 is further configured to determine a first number of sessions corresponding to the running data; determine, based on the state feedback information, that the running data corresponds to a second number of sessions during which the target operation failed to be performed successfully; and determine a performing failure rate of the target operation based on a ratio of the first number to the second number.

In some embodiments, the obtaining module 910 is further configured to, in response to that the server establishes a connection with a given client of the at least one client, receive from the given client at least a portion of the running data, the at least a portion of the running data indicating a last act performed in the plurality of acts during performing the target operation at the given client.

In some embodiments, the apparatus 900 further includes a failure analysis module configured to, for a second act of the plurality of acts, determine, for a second act of the plurality of acts, running state data where the second act fails to be performed successfully based on the state feedback information; and analyze, for the target application, a failure cause related to the second act based on the running state data.

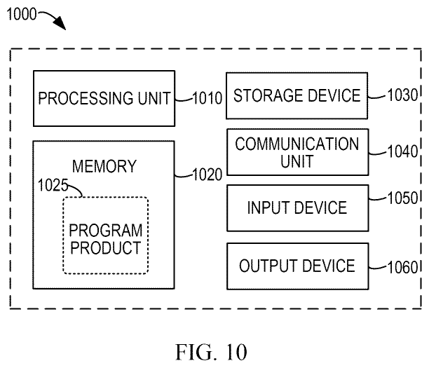

FIG. 10 illustrates a block diagram of an electronic device 1000 in which one or more embodiments of the present disclosure may be implemented. It should be understood that the electronic device 1000 illustrated in FIG. 10 is merely example and should not constitute any limitation on the functionality and scope of the embodiments described herein. The electronic device 1000 shown in FIG. 10 may be configured to implement the electronic device 110 in FIG. 1.

As shown in FIG. 10, the electronic device 1000 is in the form of a general-purpose electronic device. Components of the electronic device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and capable of performing various processes according to programs stored in the memory 1020. In a multiprocessor system, a plurality of processing units perform computer-executable instructions in parallel to improve parallel processing capabilities of the electronic device 1000.

The electronic device 1000 typically includes a plurality of computer storage media. Such media may be any available media accessible to the electronic device 1000, including, but not limited to, volatile and non-volatile media, removable and non-removable media. The memory 1020 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 1030 may be a removable or non-removable medium and may include a machine-readable medium, such as a flash drive, magnetic disk, or any other medium, which may be capable of storing information and/or data and may be accessed within the electronic device 1000.

The electronic device 1000 may further include additional removable/non-removable, volatile/non-volatile storage media. Although not shown in FIG. 10, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 1020 may include a computer program product 1025 having one or more program modules configured to perform various methods or acts of various embodiments of the present disclosure.

The communication unit 1040 is configured to communicate with a further electronic device through a communication medium. Additionally, the functionality of components of the electronic device 1000 may be implemented in a single computing cluster or multiple computing machines capable of communicating over a communication connection. Thus, the electronic device 1000 may operate in a networked environment using logical connections with one or more other servers, network personal computers (PCs), or a further network node.

The input device 1050 may be one or more input devices such as a mouse, a keyboard, a trackball, or the like. The output device 1060 may be one or more output devices, such as a display, a speaker, a printer, or the like. The electronic device 1000 may also communicate with one or more external devices (not shown) through the communication unit 1040 as needed, external devices such as storage devices, display devices, etc., communicate with one or more devices that enable a user to interact with the electronic device 1000, or communicate with any device (e.g., a network card, a modem, etc.) that enables the electronic device 1000 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or acts, or may be implemented in a combination of dedicated hardware and computer instructions.

Various implementations of the present disclosure have been described above, which are for example, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method of application performance detection, comprising:
obtaining running data resulting from a target application performing a target operation, the target operation comprising a plurality of acts, the running data at least indicating a last act of the plurality of acts performed by the target application during performing the target operation at least one client;
determining, based on the running data, state feedback information for the plurality of acts, the state feedback information indicating a performed state of each act of the plurality of acts; and
determining, based on the state feedback information, performance information of the target application.

2. The method of claim 1, wherein determining the state feedback comprises:
in response to the running data indicating that the last act performed is a first act of the plurality of acts, adding a failure record corresponding to the first act in the state feedback information.

3. The method of claim 1, wherein the running data corresponds to a plurality of sessions for performing the target operation, and the running data comprises data resulting from performing the target operation during each of the plurality of sessions.

4. The method of claim 1, wherein determining performance information of the target application comprises:
determining a first number of sessions corresponding to the running data;
determining, based on the state feedback information, that the running data corresponds to a second number of sessions during which the target operation failed to be performed successfully; and
determining a performing failure rate of the target operation based on a ratio of the first number to the second number.

5. The method of claim 1, further comprising:
determining, for a second act of the plurality of acts, running state data where the second act fails to be performed successfully based on the state feedback information; and
analyzing, for the target application, a failure cause related to the second act based on the running state data.

6. The method of claim 1, wherein the method is performed at a server of the target application, and obtaining running data resulting from a target application performing a target operation comprises:
in response to that the server establishes a connection with a given client of the at least one client, receiving from the given client at least a portion of the running data, the at least a portion of the running data indicating a last act performed in the plurality of acts during performing the target operation at the given client.

7. The method of claim 6, wherein the at least a portion of the running data comprises a plurality of data entries respectively corresponding to a plurality of performing times of the target operation at the given client, and the plurality of data entries are stored at the given client in a queue before the connection is established.

8. The method of claim 1, wherein the target operation comprises playing a media content in the target application.

9. An electronic device, comprising:
at least one processing unit; and
at least one memory coupled to the at least one processing unit and storing instructions for execution by the at least one processing unit, the instructions, when executed by the at least one processing unit, causing the electronic device to perform acts comprising:
obtaining running data resulting from a target application performing a target operation, the target operation comprising a plurality of acts, the running data at least indicating a last act of the plurality of acts performed by the target application during performing the target operation at at least one client;
determining, based on the running data, state feedback information for the plurality of acts, the state feedback information indicating a performed state of each act of the plurality of acts; and
determining, based on the state feedback information, performance information of the target application.

10. The electronic device of claim 9, wherein determining the state feedback comprises:
in response to the running data indicating that the last act performed is a first act of the plurality of acts, adding a failure record corresponding to the first act in the state feedback information.

11. The electronic device of claim 9, wherein the running data corresponds to a plurality of sessions for performing the target operation, and the running data comprises data resulting from performing the target operation during each of the plurality of sessions.

12. The electronic device of claim 9, wherein determining performance information of the target application comprises:
determining a first number of sessions corresponding to the running data;
determining, based on the state feedback information, that the running data corresponds to a second number of sessions during which the target operation failed to be performed successfully; and
determining a performing failure rate of the target operation based on a ratio of the first number to the second number.

13. The electronic device of claim 9, wherein the acts further comprise:
determining, for a second act of the plurality of acts, running state data where the second act fails to be performed successfully based on the state feedback information; and
analyzing, for the target application, a failure cause related to the second act based on the running state data.

14. The electronic device of claim 9, wherein obtaining running data resulting from a target application performing a target operation comprises:
in response to that the server establishes a connection with a given client of the at least one client, receiving from the given client at least a portion of the running data, the at least a portion of the running data indicating a last act performed in the plurality of acts during performing the target operation at the given client.

15. The method of claim 14, wherein the at least a portion of the running data comprises a plurality of data entries respectively corresponding to a plurality of performing times of the target operation at the given client, and the plurality of data entries are stored at the given client in a queue before the connection is established.

16. The electronic device of claim 9, wherein the target operation comprises playing a media content in the target application.

17. A non-transitory computer-readable storage medium having a computer program stored thereon, the computer program being executable by a processor to implement acts comprising:
obtaining running data resulting from a target application performing a target operation, the target operation comprising a plurality of acts, the running data at least indicating a last act of the plurality of acts performed by the target application during performing the target operation at at least one client;
determining, based on the running data, state feedback information for the plurality of acts, the state feedback information indicating a performed state of each act of the plurality of acts; and
determining, based on the state feedback information, performance information of the target application.

18. The computer-readable storage medium of claim 17, wherein determining the state feedback comprises:
in response to the running data indicating that the last act performed is a first act of the plurality of acts, adding a failure record corresponding to the first act in the state feedback information.

19. The computer-readable storage medium of claim 17, wherein the running data corresponds to a plurality of sessions for performing the target operation, and the running data comprises data resulting from performing the target operation during each of the plurality of sessions.

20. The computer-readable storage medium of claim 17, wherein determining performance information of the target application comprises:
determining a first number of sessions corresponding to the running data;
determining, based on the state feedback information, that the running data corresponds to a second number of sessions during which the target operation failed to be performed successfully; and
determining a performing failure rate of the target operation based on a ratio of the first number to the second number.
